(19) United States
(12) Patent Application Publication
(10) Pub. No.: US 2025/0306310 A1
(43) Pub. Date: Oct. 2, 2025

(54) OPTICAL MODULE WITH SPATIAL SEPERATION BETWEEN OPTICAL FIBER AND OPTICAL COMMUNICATION ASSEMBLY AND OPTICAL COUPLING CONFIGURATION THEREOF

(71) Applicant: Prime World International Holdings Ltd., New Taipei City (TW)

(72) Inventors: Yi-Jheng WONG, New Taipei City (TW); Che-Shou YEH, New Taipei City (TW); Jian-Hong LUO, New Taipei City (TW); Hung-Yen LIN, New Taipei City (TW)

(21) Appl. No.: 18/753,061

(22) Filed: Jun. 25, 2024

(30) Foreign Application Priority Data
Apr. 1, 2024 (TW) 113112396

(51) Int. Cl. G02B 6/42; G02B 6/36

(52) U.S. Cl. CPC G02B 6/4249; G02B 6/3636; G02B 6/4206; G02B 6/425; G02B 6/4274; G02B 6/4289

(57) ABSTRACT

The present disclosure provides an optical module, including a housing, a substrate, and an optical coupling configuration. The substrate is disposed in the housing. The optical coupling configuration includes an optical communication assembly and a bending fiber array. The optical communication assembly is disposed on the substrate. The optical communication assembly includes an optical communication unit and an electronic component, and the optical communication unit is electrically connected to the electronic component via a metal wire. The bending fiber array is optically coupled to the optical communication unit, and the bending fiber array is spatially spaced apart from the optical communication unit and the metal wire.

### CROSS-REFERENCE TO RELATED APPLICATIONS

This non-provisional application claims priority under 35 U.S.C. § 119 (a) on Patent Application No(s). 113112396 filed in Taiwan, ROC on Apr. 1, 2024, the entire contents of which are hereby incorporated by reference.

### BACKGROUND

### 1. Technical Field

This disclosure relates to an optical module and an optical coupling configuration of the optical module.

### 2. Related Art

Optical modules are usually installed in an electronic communication apparatus of high-speed communication networks. In order to enhance the compatibility of optical internetworking products all over the world and to reduce the burden of maintenance, organizations such as Multi-Source Agreement (MSA), Institute of Electrical and Electronic Engineers (IEEE), and Optical Internetworking Forum (OIF) have developed several form factors adapted to different signal transmission rates. These form factors include, but not limited to, 10 Gbps XFP, 40 Gbps QSFP (Quad Small Form Factor Pluggable), 100 Gbps QSFP28, 400 Gbps QSFP-DD (Double Density), 800 Gbps QSFP-DD, 1.6 Tbps OSFP (Octal Small Form Factor Pluggable), and 3.2 Tbps CPO (Co-Packaged Optics).

However, the existing optical module still presents some problems to be solved.

### SUMMARY

According to one aspect of the present disclosure, an optical module includes a housing, a substrate, and an optical coupling configuration. The substrate is disposed in the housing. The optical coupling configuration includes an optical communication assembly and a bending fiber array. The optical communication assembly is disposed on the substrate. The optical communication assembly includes an optical communication unit and an electronic component, and the optical communication unit is electrically connected to the electronic component via a metal wire. The bending fiber array is optically coupled to the optical communication unit, and the bending fiber array is spatially spaced apart from the optical communication unit and the metal wire.

According to another aspect of the present disclosure, an optical module includes a housing, a substrate, and an optical coupling configuration. The substrate is disposed in the housing. The optical coupling configuration includes a first optical communication assembly, a second optical communication assembly, and a bending fiber array. The first optical communication assembly and the second optical communication assembly are disposed on the substrate. The second optical communication assembly includes an optical communication unit and an electronic component, and the optical communication unit is electrically connected to the electronic component via a metal wire. The bending fiber array crosses first optical communication assembly and optically coupled to the optical communication unit of the second optical communication assembly, and the bending fiber array is spatially spaced apart from the optical communication unit and the metal wire.

According to still another aspect of the present disclosure, an optical coupling configuration in an optical module includes an optical communication assembly and a bending fiber array. The optical communication assembly includes an optical communication unit and an electronic component, and the optical communication unit is electrically connected to electronic component via a metal wire. The bending fiber array is optically coupled to the optical communication unit, and the bending fiber array is spatially spaced apart from the optical communication unit and the metal wire.

### BRIEF DESCRIPTION OF THE DRAWINGS

The present disclosure will become better understood from the detailed description given hereinbelow and the accompanying drawings which are given by way of illustration only and thus are not intended to limit the present disclosure and wherein:

FIG. 1 is a schematic view of an optical module according to one embodiment of the present disclosure;

FIG. 2 is a side view of the optical module in FIG. 1;

FIG. 3 is a partially enlarged view of the optical module in FIG. 1;

FIG. 4 is a front view of an optical coupling configuration in FIG. 3;

FIG. 5 is a side view of the optical coupling configuration in FIG. 4;

FIG. 6 is a side view of an optical coupling configuration according to another embodiment of the present disclosure;

FIG. 7 is a side view of an optical coupling configuration according to still another embodiment of the present disclosure;

FIG. 8 is a side view of an optical coupling configuration according to yet another embodiment of the present disclosure;

FIG. 9 is a side view of an optical coupling configuration according to yet another embodiment of the present disclosure; and

FIG. 10 is a schematic view of an optical communication system according to one embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

In compliance with the form factor, with the increasing demands for optical modules that are small and have a large number of channels, one of the problems to be solved in the relevant industry is to provide optical modules that can be configured with more active components or passive components associated with optical communication. For certain form factors, replacing the existing internal optical fibers or pigtails with a bending fiber array can improve the space utilization inside the optical module, so it is considered a feasible solution. Usually, active components for optical communication are electrically connected to each other through wire bonding. However, an end of the optical fiber will spatially interfere the wiring easily due to the arrangement of the bending fiber array. Specifically, the end of the optical fiber that is broken or bent may interfere the wiring.

According to one embodiment of the present disclosure, the bending fiber array is spatially spaced apart from the optical communication unit, and also spatially spaced apart from the metal wire. There may be an air gap between the bending fiber array and the optical communication unit, and there may also be an air gap between the bending fiber array and the metal wire. Since a position of the bending fiber array is raised to a higher altitude, the bending fiber array will not be in contact with the optical communication unit, and the metal wire will not be broken or bent, either.

Some or all of the technical features disclosed in one or more embodiments of the present disclosure may be combined to achieve corresponding effects.

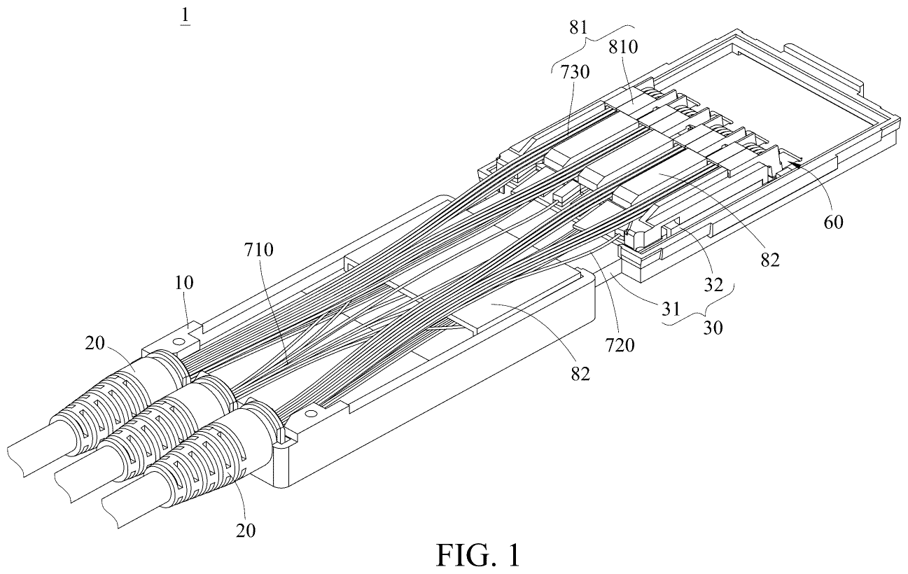

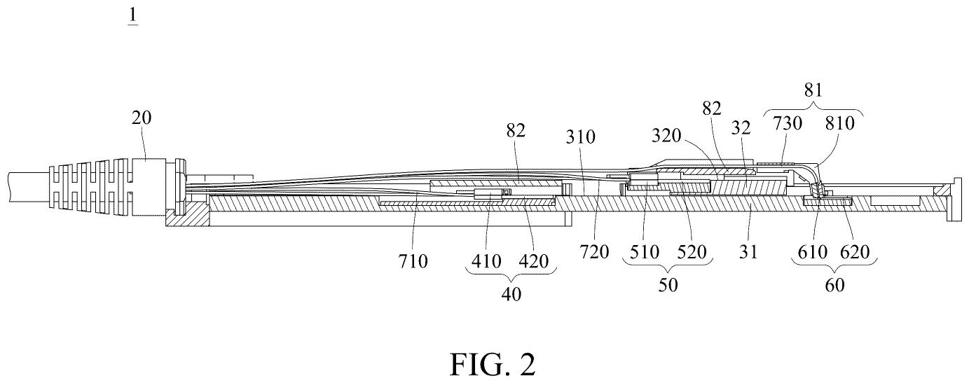

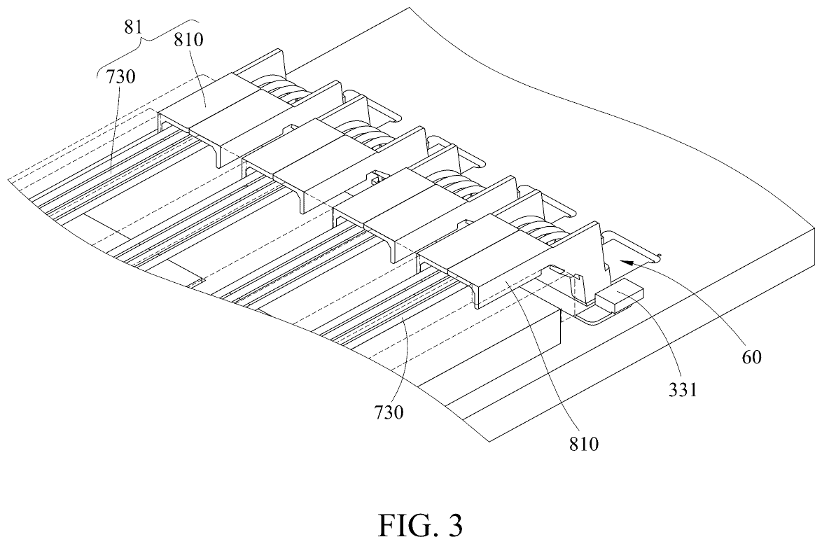

Please refer to FIGS. 1 to 3. FIG. 1 is a schematic view of an optical module 1 according to one embodiment of the present disclosure, FIG. 2 is a side view of the optical module 1 in FIG. 1, and FIG. 3 is a partially enlarged view of the optical module 1 in FIG. 1. In this embodiment, the optical module 1 may include a housing 10, an optical coupler 20, a substrate 30, an optical communication assembly 40, an optical communication assembly 50, an optical communication assembly 60, and a plurality of internal optical fibers. In order to facilitate the understanding of the present disclosure, the housing 10 is omitted from FIG. 3. The optical module 1 may be understood as an optical transceiver.

The housing 10 may be a housing integrally formed as a single piece, or the housing 10 may be a multi-part housing including an upper housing part and a lower housing part. The housing 10 may be a housing adapted to CPO configuration defined by OIF, but this form factor is not intended to limit the present disclosure.

The optical coupler 20 may be disposed on the housing 10. Further, at least a part of the optical coupler 20 may be exposed to the outside. One end of the internal optical fiber may be coupled to the optical coupler 20. FIG. 1 exemplarily illustrates that the optical module 1 includes three optical couplers 20, but the number of the optical couplers 20 is not intended to limit the present disclosure. The optical coupler 20 may be understood as an optical fiber connector with boot or an active optical cable (AOC).

The substrate 30 may be a printed circuit board assembly (PCBA), or may include a plurality of independent PCBAs. In this embodiment, the substrate 30 may include a motherboard 31 and a daughter board 32. The motherboard 31 and the daughter board 32 may be disposed in the housing 10, and the daughter board 32 may be disposed on a top surface 310 of the motherboard 31. In one embodiment, the daughter board 32 may be fixed onto the top surface 310 to realize the electrical connection between circuits of the daughter board 32 and circuits of the motherboard 31. Besides, the daughter board 32 may have a mounting surface 320 located opposite to the top surface 310. Further, the mounting surface 320 may be a top surface of the daughter board 32.

The optical communication assembly 40 may be disposed on the substrate 30. Further, the optical communication assembly 40 may include an electronic component 420 and an optical communication unit 410 disposed on the top surface 310 of the motherboard 31. For example, the optical communication unit 410 may be a laser diode, and the electronic component 420 may be a laser driver chip. Further, the electronic component 420 may be understood as a photonic integrated circuit (PIC). The optical communication assembly 40 may further include an optical modulator, a wavelength division multiplexer, a collimating lens and/or a digital signal processor (DSP). FIG. 1 exemplarily illustrates two optical communication assemblies 40, and each of the optical communication assemblies 40 includes two optical communication units 410. However, the number of the optical communication assemblies 40 is not intended to limit the present disclosure.

The optical communication assembly 50 may be disposed on the substrate 30. Further, the optical communication assembly 50 may include an electronic component 520 and an optical communication unit 510 disposed on the mounting surface 320 of the daughter board 32. For example, the optical communication unit 510 may be a laser diode, and the electronic component 520 may be a laser driver chip. Further, the electronic component 520 may be understood as a PIC. The optical communication assembly 50 may further include an optical modulator, a wavelength division multiplexer, a collimating lens and/or a digital signal processor (DSP). FIG. 1 exemplarily illustrates two optical communication assemblies 50, and each of the optical communication assemblies 50 includes two optical communication units 510. However, the number of the optical communication assemblies 50 is not intended to limit the present disclosure.

The optical communication assembly 60 may be disposed on the substrate 30. Further, the optical communication assembly 60 may include an electronic component 620 and an optical communication unit 610 disposed on the top surface 310 of the motherboard 31. For example, the optical communication unit 610 may be a photodiode, and the electronic component 620 may be a transimpedance amplifier. Further, the electronic component 620 may be understood as an electronic integrated circuit (EIC). The optical communication unit 610 may be electrically connected to the electronic component 620 via a metal wire 61. In one embodiment, the optical communication unit 610 may be connected to the electronic component 620 through wire bonding. The optical communication assembly 60 may further include a wavelength division demultiplexer and/or a DSP. FIG. 3 exemplarily illustrates eight optical communication assemblies 60, and each of the optical communication assemblies 60 includes four optical communication units 610. However, the number of the optical communication assemblies 60 is not intended to limit the present disclosure. Besides, FIG. 3 also illustrate eight optical communication assemblies 60 arranged in two rows with four optical communication assemblies 60 arranged in each row, but the present disclosure is not limited thereto.

In some embodiments, the optical communication unit 410 of the optical communication assembly 40 may be a photodiode, and the electronic component 420 may be a transimpedance amplifier. In some embodiments, the optical communication unit 510 of the optical communication assembly 50 may be a photodiode, and the electronic component 520 may be a transimpedance amplifier. In some embodiments, the optical communication unit 610 of the optical communication assembly 60 may be a laser diode, and the electronic component 620 may be a laser driver chip.

In some embodiments, the optical module 1 may not include the optical communication assembly 40 or the optical communication assembly 50 as shown in FIG. 1. In some embodiments, the optical module 1 may only include the optical communication assembly 60 instead of including the optical communication assembly 40 and the optical communication assembly 50 as shown in FIG. 1.

In some embodiments, the optical communication assemblies 40 and 50 may be understood as a transmitting optical sub-assembly (TOSA) module. In some embodiments, the optical communication assembly 60 may be understood as a receiver optical sub-assembly (ROSA) module.

The internal optical fiber may be understood as a pigtail or a jumper. The internal optical fiber may include an internal optical fiber 710 optically coupling the optical communication assembly 40 and the optical coupler 20, an internal optical fiber 720 optically coupling the optical communication assembly 50 and the optical coupler 20, and an internal optical fiber 730 optically coupling the optical communication assembly 60 and the optical coupler 20. FIG. 1 exemplarily illustrates four internal optical fibers 710, four internal optical fibers 720, and eight internal optical fibers 730 that are ribbon fiber optic cables. However, the number of the optical fibers is not intended to limit the present disclosure.

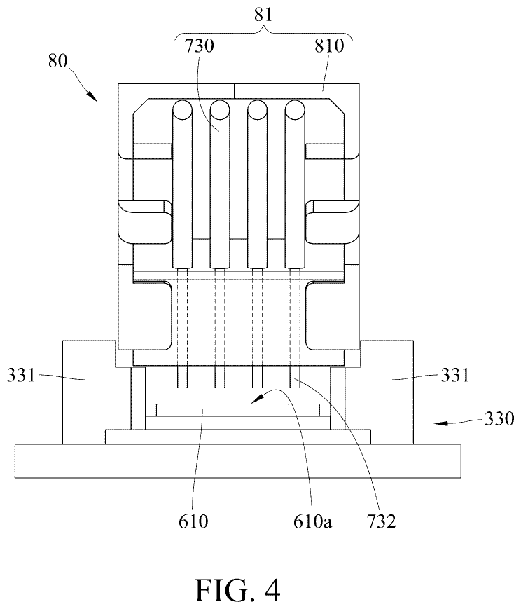

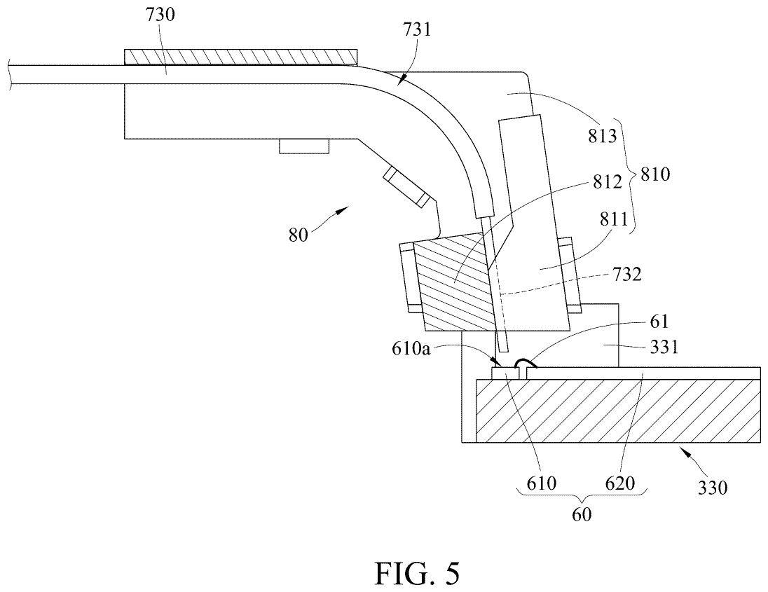

In this embodiment, the optical coupling configuration 80 of the optical module 1 may include the aforesaid optical communication assembly 60 and a bending fiber array 81 including the internal optical fiber 730. Please refer to FIG. 4 and FIG. 5 together. FIG. 4 is a front view of an optical coupling configuration 80 in FIG. 3, and FIG. 5 is a side view of the optical coupling configuration 80 in FIG. 4. As shown in FIG. 2, FIG. 4, and FIG. 5, the bending fiber array 81 may include a carrier 810 and an internal optical fiber 730. The internal optical fiber 730 is disposed on the carrier 810 and optically coupled to the optical communication unit 610 of the optical communication assembly 60. The carrier 810 accommodates the internal optical fiber 730 and bends the internal optical fiber 730. Further, the carrier 810 may include a base 811, a cover body 812, and an internal optical fiber 730. The internal optical fiber 730 is disposed between the base 811 and the cover body 812. The base 811 may have a groove accommodating the internal optical fiber 730. In one embodiment, the groove may be understood as a V groove. The carrier 810 may also include a clamp 813 that bends the internal optical fiber 730 to have a bending part 731.

The bending fiber array 81 is spatially spaced apart from each of the optical communication unit 610 and the metal wire 61. As shown in FIG. 4 and FIG. 5, the internal optical fiber 730 has a bare fiber end part 732, and at least a part of the bare fiber end part 732 protrudes out of the base 811 toward the optical communication unit 610. Each of the base 811, the cover body 812, and the bare fiber end part 732 is spatially spaced apart from each of the optical communication unit 610 and the metal wire 61. Further, the term “spatially spaced apart from” denotes that two objects are not in direct physical contact with each other, and there is no indirect physical contact between these two objects via any intervening object, while something in a space between these two objects is allowable.

In one embodiment, an upper surface of the optical communication unit 610 has an optically active area 610a proximate to the metal wire 61, and the optically active area 610a may be understood as a light-emitting area of the laser diode or a light-receiving area of the photodiode. The base 811 has an end surface facing the optically active area 610a and spatially spaced apart from the optically active area 610a. The cover body 812 has an end surface facing the optically active area 610a and spatially spaced apart from the optically active area 610a. An end surface of the bare fiber end part 732 is spatially spaced apart from the optically active area 610a. The end surface of the base 811 is spatially spaced apart from the metal wire 61. The end surface of the cover body 812 is spatially spaced apart from the metal wire 61. The end surface of the bare fiber end part 732 is spatially spaced apart from metal wire 61.

In one embodiment, at least part of the bending fiber array 81 may be located above the metal wire 61. In one embodiment, the base 811 of the bending fiber array 81 may be located above the metal wire 61, as shown in FIG. 5. In one embodiment, the cover body 812 of the bending fiber array 81 may be located above the metal wire 61. In one embodiment, both the base 811 and the cover body 812 may be located above the metal wire 61.

According to one embodiment of the present disclosure, the carrier 810 of the bending fiber array 81 may rest on the substrate 30. As shown in FIG. 4, the motherboard 31 of the substrate 30 may include a carrier 330 configured to support the optical communication assembly 60, and the carrier 330 may have two protruding parts 331. At least one of the base 811 and the cover body 812 of the carrier 810 rests on the protruding parts 331. In this way, the bending fiber array 81 is able to be spatially spaced apart from the optical communication unit 610 and the metal wire 61. In one embodiment, the cover body 812 may be abutted against the top surface of the protruding part 331.

In one embodiment, the protruding part 331 may be a bump of the substrate 30. In one embodiment, the protruding part 331 may be a carrier located on the top surface of the substrate 30 and made of epoxy. In one embodiment, the protruding part 331 may be an element fixed to the substrate 30 and capable of engaged with the bending fiber array 81.

In one embodiment, the base 811 rests on the protruding parts 331, and the base 811 supports the cover body 812 with the cover body 812 apart from the protruding parts 331. In one embodiment, the cover body 812 rests on the protruding parts 331, and the cover body 812 supports the base 811 with the base 811 apart from the protruding parts 331. In one embodiment, both the base 811 and the cover body 812 rest on the protruding parts 331.

Since a position of the bending fiber array 81 is raised to a higher altitude, the bending fiber array 81 will not be in contact with the optical communication unit 610, and the metal wire 61 will not be broken or bent, either. In this embodiment, the protruding part 331 of the substrate 30 is configured to maintain the position of the bending fiber array 81 at an altitude where the bending fiber array 81 does not be in contact with the optical communication unit 610 and the metal wire 61. However, any technical means that can raise the bending fiber array 81 can be regarded as belonging to the scope of the present disclosure.

According to one embodiment of the present disclosure, the optical module 1 may further include an upper cover 82 disposed above the optical communication assembly 40 or the optical communication assembly 50. As shown in FIG. 1 and FIG. 2, the internal optical fiber 730 of the bending fiber array 81 crosses the optical communication assembly 40 and the optical communication assembly 50, and also crosses the upper cover 82. The upper cover 82 prevents the optical fiber from interfering the optical transmission of the optical communication assembly located therebelow.

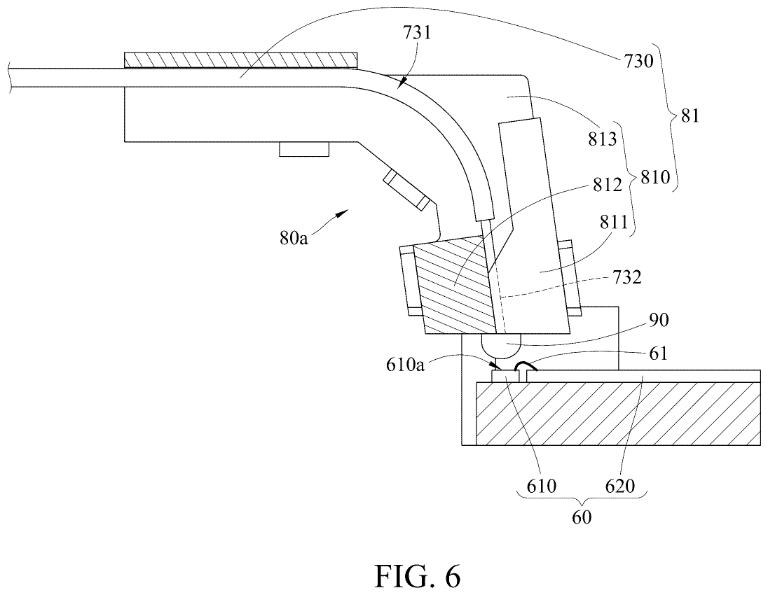

The optical coupling configuration of the optical module is not limited to the configuration shown in FIG. 5. Please refer to FIG. 6. FIG. 6 is a side view of an optical coupling configuration 80a according to another embodiment of the present disclosure. In this embodiment, the optical coupling configuration 80a adapted to the optical module may include an optical communication assembly 60 and a bending fiber array 81, and may further include an optical lens 90. The optical lens 90 is disposed on at least one of the base 811 of the bending fiber array 81 and the cover body 812, and at least a part of the optical lens 90 is located between the internal optical fiber 730 and the optical communication unit 610. In one embodiment, the end surface of the bare fiber end part 732 of the internal optical fiber 730 is aligned with the end surface of the base 811 and the end surface of the cover body 812. The optical lens 90 is disposed at a position where the end surface of the base 811 and the end surface of the cover body 812 intersect, and the optical lens 90 is spatially spaced apart from the optical communication unit 610 and the metal wire 61. The optical lens 90 may improve the optically coupling efficiency between the internal optical fiber 730 and the optically active area 610a of the optical communication unit 610.

In one embodiment, the bare fiber end part 732 may include a core and a cladding of the internal optical fiber 730. In one embodiment, the bare fiber end part 732 may include only a core of the internal optical fiber 730.

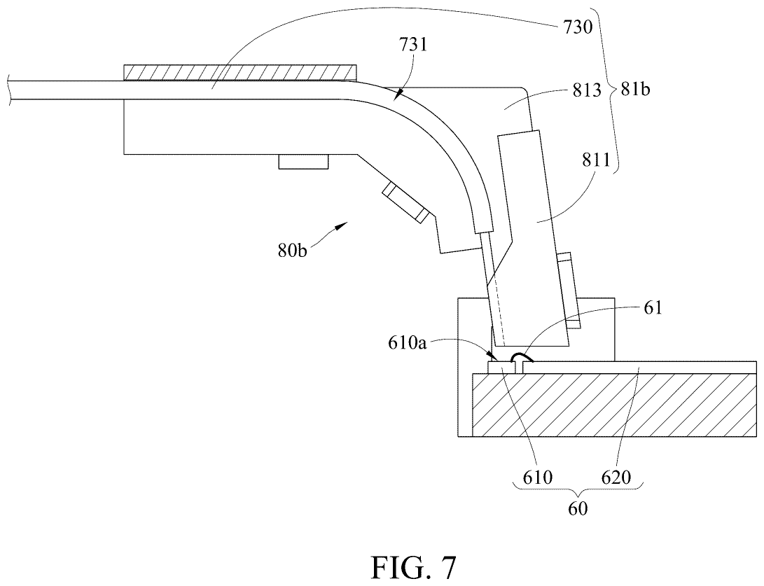

Please refer to FIG. 7. FIG. 7 is a side view of an optical coupling configuration 80b according to still another embodiment of the present disclosure. In this embodiment, the optical coupling configuration 80b adapted to the optical module may include an optical communication assembly 60 and a bending fiber array 81b. Different from the bending fiber array 81 shown in FIG. 5, the bending fiber array 81b shown in FIG. 7 may not include the cover body 812. The bending fiber array 81b may include a base 811, an internal optical fiber 730, and a clamp 813. The internal optical fiber 730 may be disposed on the base 811. The base 811 may have a V groove accommodating the internal optical fiber 730. The clamp 813 bends the internal optical fiber 730 to have a bending part 731.

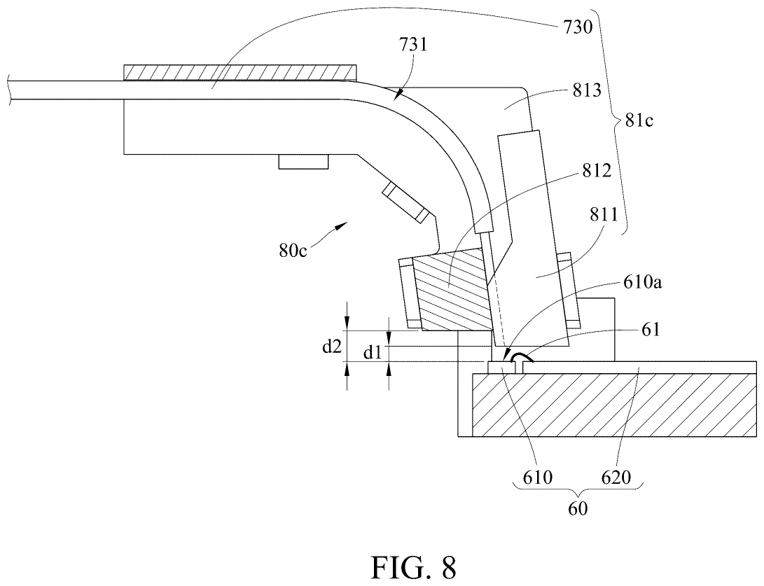

Please refer to FIG. 8. FIG. 8 is a side view of an optical coupling configuration 80c according to yet another embodiment of the present disclosure. In this embodiment, the optical coupling configuration 80c adapted to the optical module may include an optical communication assembly 60 and a bending fiber array 81c. A minimum distance d1 between the base 811 of the bending fiber array 81c and the optical communication unit 610 may be less than a minimum distance d2 between the cover body 812 and the optical communication unit 610. Further, the minimum distance d1 may be understood as a vertical distance from the end surface of the base 811 to the optically active area 610a of the optical communication unit 610, and the minimum distance d2 may be understood as a vertical distance from the end surface of the cover body 812 to the optically active area 610a. In one embodiment, the end surface of the base 811 may be located closer to the optically active area 610a of the optical communication unit 610 than the end surface of the cover body 812.

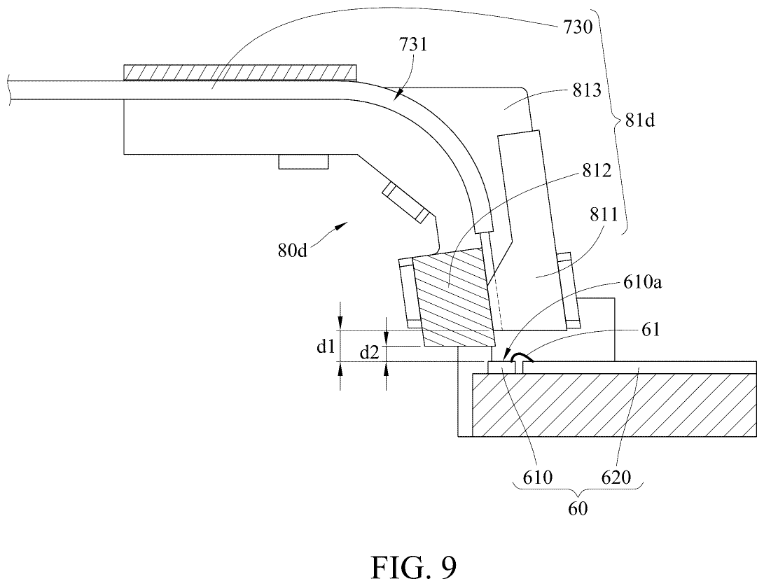

Please refer to FIG. 9. FIG. 9 is a side view of an optical coupling configuration 80d according to yet another embodiment of the present disclosure. In this embodiment, the optical coupling configuration 80d adapted to the optical module may include an optical communication assembly 60 and a bending fiber array 81d. The minimum distance d1 between the base 811 of the bending fiber array 81d and the optical communication unit 610 may be greater than the minimum distance d2 between the cover body 812 and the optical communication unit 610. In one embodiment, the end surface of the cover body 812 may be located closer to the optically active area 610a of the optical communication unit 610 than the end surface of the base 811.

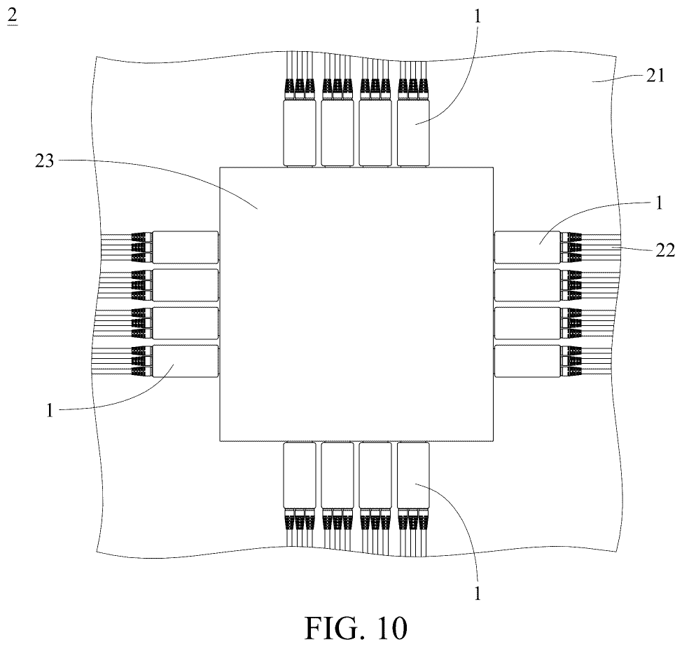

FIG. 10 is a schematic view of an optical communication system 2 according to one embodiment of the present disclosure. The optical communication system 2 may include the optical module 1 as shown in FIG. 1, and the optical module 1 may be fixed onto a carrier board 21 including an application-specific integrated circuit (ASIC) chip 23. An optical port of the optical module 1 may be optically coupled to an external optical fiber 22, and an electrical port of the optical module 1 may be electrically connected to the ASIC chip 23. FIG. 10 exemplarily illustrates that the optical communication system 2 includes a total of sixteen optical modules 1, where each of the optical modules 1 may have a signal transmission rate of 3.2 Tbps, and the ASIC chip 23 may have a signal transmission rate of 51.2 Tbps.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An optical module, comprising:
a housing;
a substrate, disposed in the housing; and
an optical coupling configuration, comprising:
an optical communication assembly, disposed on the substrate, wherein the optical communication assembly comprises an optical communication unit and an electronic component, and the optical communication unit is electrically connected to the electronic component via a metal wire; and
a bending fiber array, optically coupled to the optical communication unit, wherein the bending fiber array is spatially spaced apart from the optical communication unit and the metal wire.

2. The optical module according to claim 1, wherein the optical communication unit comprises a photodiode, and the electronic component comprises a transimpedance amplifier.

3. The optical module according to claim 1, wherein the substrate has two protruding parts, the bending fiber array comprises a carrier and an optical fiber, the optical fiber is disposed on the carrier and optically coupled to the optical communication unit, and the carrier rests on the two protruding parts.

4. The optical module according to claim 1, wherein the bending fiber array comprises a base, a cover body, and an optical fiber, the optical fiber is disposed between the base and the cover body and optically coupled to the optical communication unit, the base has a groove accommodating the optical fiber, the optical fiber has a bending part, and each of the base, the cover body, and the optical fiber is spatially spaced apart from the optical communication unit and the metal wire.

5. The optical module according to claim 4, wherein the optical fiber has a bare fiber end part, and at least a part of the bare fiber end part protrudes out of the base toward the optical communication unit.

6. The optical module according to claim 4, wherein the bending fiber array further comprises an optical lens, the optical lens is disposed on at least one of the base and the cover body, and at least a part of the optical lens is located between the optical fiber and the optical communication unit.

7. The optical module according to claim 4, wherein a minimum distance between the base and the optical communication unit is less than a minimum distance between the cover body and the optical communication unit.

8. The optical module according to claim 4, wherein a minimum distance between the base and the optical communication unit is greater than a minimum distance between the cover body and the optical communication unit.

9. The optical module according to claim 1, wherein the bending fiber array comprises a base and an optical fiber, the optical fiber is disposed on the base and optically coupled to the optical communication unit, the base has a groove accommodating the optical fiber, the optical fiber has a bending part, and each of the base and the optical fiber is spatially spaced apart from the optical communication unit and the metal wire.

10. The optical module according to claim 1, wherein at least part of the bending fiber array is located above the metal wire.

11. An optical module, comprising:
a housing;
a substrate, disposed in the housing; and
an optical coupling configuration, comprising:
a first optical communication assembly and a second optical communication assembly, disposed on the substrate, wherein the second optical communication assembly comprises an optical communication unit and an electronic component, and the optical communication unit is electrically connected to the electronic component via a metal wire; and
a bending fiber array, crossing the first optical communication assembly and optically coupled to the optical communication unit of the second optical communication assembly, wherein the bending fiber array is spatially spaced apart from the optical communication unit and the metal wire.

12. The optical module according to claim 11, wherein the first optical communication assembly comprises a laser diode, the optical communication unit of the second optical communication assembly comprises a photodiode, and the electronic component of the second optical communication assembly comprises a transimpedance amplifier.

13. The optical module according to claim 11, wherein the substrate has two protruding parts, the bending fiber array comprises a carrier and an optical fiber, the optical fiber is disposed on the carrier, and the carrier rests on the two protruding parts.

14. The optical module according to claim 11, further comprising an upper cover disposed above the first optical communication assembly, wherein an optical fiber of the bending fiber array is optically coupled to the optical communication unit of the second optical communication assembly, and the optical fiber crosses the upper cover.

15. The optical module according to claim 11, wherein at least part of the bending fiber array is located above the metal wire.

16. An optical coupling configuration in an optical module, comprising:
an optical communication assembly, comprising an optical communication unit and an electronic component, and the optical communication unit is electrically connected to the electronic component via a metal wire; and
a bending fiber array, optically coupled to the optical communication unit, wherein the bending fiber array is spatially spaced apart from the optical communication unit and the metal wire.

17. The optical coupling configuration in the optical module according to claim 16, wherein the optical communication unit comprises a photodiode, and the electronic component comprises a transimpedance amplifier.

18. The optical coupling configuration in the optical module according to claim 16, wherein the bending fiber array comprises a base, a cover body, and an optical fiber, the optical fiber is disposed between the base and the cover body and optically coupled to the optical communication unit, the base has a groove accommodating the optical fiber, the optical fiber has a bending part, and each of the base, the cover body, and the optical fiber is spatially spaced apart from the optical communication unit and the metal wire.

19. The optical coupling configuration in the optical module according to claim 16, wherein the bending fiber array comprises a base and an optical fiber, the optical fiber is disposed on the base and optically coupled to the optical communication unit, the base has a groove accommodating the optical fiber, the optical fiber has a bending part, and each of the base and the optical fiber is spatially spaced apart from the optical communication unit and the metal wire.

20. The optical coupling configuration in the optical module according to claim 16, wherein at least part of the bending fiber array is located above the metal wire.
